(19) United States
(12) Patent Application Publication
(10) Pub. No.: US 2025/0314283 A1
(43) Pub. Date: Oct. 9, 2025

(54) MULTI-DIRECTION VIBRATION ISOLATION UNIT WITH AN ADJUSTABLE MECHANISM

(71) Applicant: City University of Hong Kong, Kowloon (HK)

(72) Inventor: Xingjian Jing, Sha Tin (HK)

(21) Appl. No.: 18/629,842

(22) Filed: Apr. 8, 2024

(51) Int. Cl. F16F 15/04

(52) U.S. Cl. CPC F16F 15/04; F16F 2230/0052

(57) ABSTRACT

A vibration suppression system includes a first support structure, a second support structure, and a plurality of resilient members. The first support structure includes: a first support member, a second support member, a third support member coupled to the second support member at a first rotation joint, and a fourth support member coupled to the first support member at a second rotation joint. The second support structure is coupled to the first support structure and includes: a fifth support member, a sixth support member coupled to the fifth support member at the first rotation joint, and a seventh support member coupled to the fifth support member at a third rotation joint. A distance between the first rotation joint and the third rotation joint is adjustable. The plurality of resilient members are coupled to at least one of the first support structure or the second support structure.

### TECHNICAL FIELD

The present disclosure relates generally to vibration suppression. More specifically, the present disclosure relates to passive vibration suppression systems.

### BACKGROUND

Vibration problems are often considered a negative factor in many engineering systems. Detrimental vibrations may significantly affect the accuracy of precision equipment, reduce service life of instruments, and cause structural fatigue damage. As such, the unwanted vibrations need to be controlled within a rational and acceptable range in engineering systems. Various vibration suppression systems attempt to address this issue, such as traditional linear passive vibration isolators, active/semi-active isolation elements, and nonlinear quasi-zero stiffness (QZS) passive isolators. There remains room for improvement, however, in the performance of typical vibration suppression systems.

For example, the mechanism structures of these vibration suppression systems are typically pre-designed according to the size, material, mass, and loading capacity requirements of a particular use case, which are not parameters that are easily changed. The adjustability and flexibility in implementation for typical vibration suppression systems is therefore limited, which increases the difficulties for these vibration suppression systems to achieve better vibration isolation performance.

### SUMMARY

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

A vibration suppression system is provided that includes a first, non-adjustable support structure and a second, adjustable support structure integrated with one another. The vibration suppression system also includes a plurality of resilient members. The first support structure is non-adjustable in that the arrangement of support members of the first support structure cannot be adjusted without at least partially disassembling the vibration suppression system, whereas the second support structure is adjustable in that the arrangement of support members of the second support structure can be adjusted while the vibration suppression system is fully assembled. For instance, distances between rotation joints of the adjustable support structure can be easily adjusted to alter the vibration suppression characteristics of the vibration suppression system according to intended engineering requirements for a particular use case.

The configuration of the non-adjustable and adjustable support structures enables the vibration suppression system to achieve adjustable nonlinear stiffness and damping characteristics in all three of the x, y, and z directions. The vibration suppression system also exhibits excellent ultra-low-frequency vibration suppression performance with a larger bandwidth in all three of the x, y, and z directions. Additionally, the vibration suppression system exhibits a wider QZS zone, larger loading capacity, and wider vibration isolation band in all three of the x, y, and z directions.

In an example, a vibration suppression system includes a first support structure, a second support structure, and a plurality of resilient members. The first support structure includes: a first support member, a second support member, a third support member coupled to the second support member at a first rotation joint, and a fourth support member coupled to the first support member at a second rotation joint. The second support structure is coupled to the first support structure and includes: a fifth support member, a sixth support member coupled to the fifth support member at the first rotation joint, and a seventh support member coupled to the fifth support member at a third rotation joint. A distance between the first rotation joint and the third rotation joint is adjustable. The plurality of resilient members are coupled to at least one of the first support structure or the second support structure.

In another example, a vibration suppression system includes a first support structure and a second support structure. The first support structure includes a first X-shaped structure and a second X-shaped structure coupled to the first X-shaped structure at a first rotation joint and at a second rotation joint. The second support structure includes a third X-shaped support structure coupled to the first support structure at the first rotation joint, and a fourth X-shaped support structure coupled to the first support structure at the second rotation joint. The third X-shaped support structure is coupled to the fourth X-shaped support structure at a third rotation joint and at a fourth rotation joint. A distance between the first rotation joint and the third rotation joint, and a distance between the first rotation joint and the fourth rotation joint, is adjustable.

In another example, a vibration suppression system includes a first support structure and a second support structure. The second support structure includes a first support member, a second support member coupled to the first support member and the first support structure at a first rotation joint, a third support member coupled to the first support member at a second rotation joint, and a fourth support member coupled to the third support member and the first support structure at a third rotation joint. The fourth support member is further coupled to the second support member at a fourth rotation joint. The second rotation joint includes a bracket through which the first support member is disposed. The bracket is configured to selectively allow or restrict translation of the first support member relative to the bracket.

In another example, a vibration suppression system includes a first support structure and a second support structure coupled to the first support structure. The first support structure includes a first plurality of support members and a first plurality of rotation joints. The second support structure includes a second plurality of support members and a second plurality of rotation joints. The second plurality of rotation joints includes a portion of the first plurality of rotation joints, and a distance between a first rotation joint of the second plurality of rotation joints and a second rotation joint of the second plurality of rotation joints is adjustable.

The term “coupled” is defined as connected, although not necessarily directly, and not necessarily mechanically; two items that are “coupled” may be unitary with each other. The terms “a” and “an” are defined as one or more unless this disclosure explicitly requires otherwise.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The terms “comprise” and any form thereof such as “comprises” and “comprising,” “have” and any form thereof such as “has” and “having,” and “include” and any form thereof such as “includes” and “including” are open-ended linking verbs. As a result, an apparatus or system that “comprises,” “has,” or “includes” one or more elements possesses those one or more elements but is not limited to possessing only those elements. Likewise, a method that “comprises,” “has,” or “includes” one or more steps possesses those one or more steps but is not limited to possessing only those one or more steps.

Any embodiment of any of the apparatuses, systems, and methods can consist of or consist essentially of—rather than comprise/have/include—any of the described steps, elements, and/or features. Thus, in any of the claims, the term “consisting of” or “consisting essentially of” can be substituted for any of the open-ended linking verbs recited above in order to change the scope of a given claim from what it would otherwise be using the open-ended linking verb.

An apparatus or system that is configured in a certain way is configured in at least that way, but it can also be configured in other ways than those specifically described.

The feature or features of one embodiment may be applied to other embodiments, even though not described or illustrated, unless expressly prohibited by this disclosure or the nature of the embodiments.

Some details associated with the embodiments are described above and others are described below.

Additional features and advantages of the disclosed method and apparatus are described in, and will be apparent from, the following Detailed Description and the Figures. The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label with a second label that distinguishes among the similar components. If just the first reference label is used in the specification, the description is applicable to any one of the similar components having the same first reference label irrespective of the second reference label. Like reference numbers and designations in the various drawings indicate like elements.

FIG. 1 is a perspective view of a vibration suppression system, according to an aspect of the present disclosure;

FIG. 2 is a perspective view of a first support structure of the vibration suppression system, according to an aspect of the present disclosure;

FIG. 3 is a perspective view of a first side of the vibration suppression system, according to an aspect of the present disclosure;

FIG. 4 is a perspective view of the first side of FIG. 3 including a plurality of resilient members, according to an aspect of the present disclosure;

FIG. 5 is a perspective view of a second support structure of the vibration suppression system, according to an aspect of the present disclosure;

FIG. 6 is an exploded view of a portion of the second support structure, according to an aspect of the present disclosure;

FIG. 7 is a perspective view of the first side of FIG. 4 including the second support structure, according to an aspect of the present disclosure; and

FIG. 8 is a schematic of the first side of the vibration suppression system, according to an aspect of the present disclosure.

### DETAILED DESCRIPTION

The detailed description set forth below, in connection with the appended drawings, is intended as a description of various configurations and is not intended to limit the scope of the disclosure to solely that described explicitly herein. Rather, the detailed description includes specific details for the purpose of providing a thorough understanding of the inventive subject matter. It will be apparent to those skilled in the art that these specific details are not required in every case.

A new and innovative passive vibration suppression system is provided that includes a first, non-adjustable support structure and a second, adjustable support structure integrated with one another. The vibration suppression system also includes a plurality of resilient members disposed in a new and innovative arrangement. The first support structure is non-adjustable in that the arrangement of support members of the first support structure cannot be adjusted without at least partially disassembling the vibration suppression system, whereas the second support structure is adjustable in that the arrangement of support members of the second support structure can be adjusted while the vibration suppression system is fully assembled. For instance, distances between rotation joints of the adjustable support structure can be easily adjusted to alter the vibration suppression characteristics (e.g., static and dynamic characteristics) of the vibration suppression system according to intended engineering requirements for a particular use case.

The vibration suppression system achieves adjustable nonlinear stiffness and damping characteristics in all three of the x, y, and z directions. The vibration suppression system also exhibits excellent ultra-low-frequency vibration suppression performance with a larger bandwidth in all three of the x, y, and z directions. Additionally, the vibration suppression system exhibits a wider QZS zone, larger loading capacity, and wider vibration isolation band in all three of the x, y, and z directions.

In any of the embodiments of the vibration suppression system, the various parameters of the vibration suppression system (e.g., rod segment lengths, spring stiffness, initial assembly angles, spring connection parameters, etc.) can be selected (e.g., tuned) to flexibly meet various requirements of the different applications of the vibration suppression system. For instance, different applications of the vibration suppression system can have their own specific requirements, such as a working displacement range, a height of the vibration isolation unit, or a payload and frequency range of external excitation. The adjustable support structure enables easily adjusting some of these parameters after the initial selection when the vibration suppression system is fully assembled.

In an example, initial assembly angles can be selected, and then by combining the selected initial assembly angles with a desired height of the working environment of the vibration suppression system, the rod segment lengths can be determined. In another example, the stiffness parameters of the springs in the vibration suppression system can be determined by adjusting the spring stiffness until the vibration suppression system satisfies the requirements of the desired payload and working displacement range. In another example still, the rod segment lengths and spring connection parameters can be adjusted to obtain a desired loading capacity and QZS zone requirements.

Rotation joints that facilitate rotation of two coupled components with respect to one another are described herein. Any suitable joint that connects two components and enables such movement may be used. For example, a bar (e.g., rod) positioned through respective openings in each of the two components, as in the illustrated embodiment, is one such suitable joint, though other could be used.

As used herein, a resilient member is an elastic component that repeatedly stores and releases mechanical energy. For example, a resilient member may be any suitable spring (e.g., coil spring, extension/tension spring, machined spring, etc.).

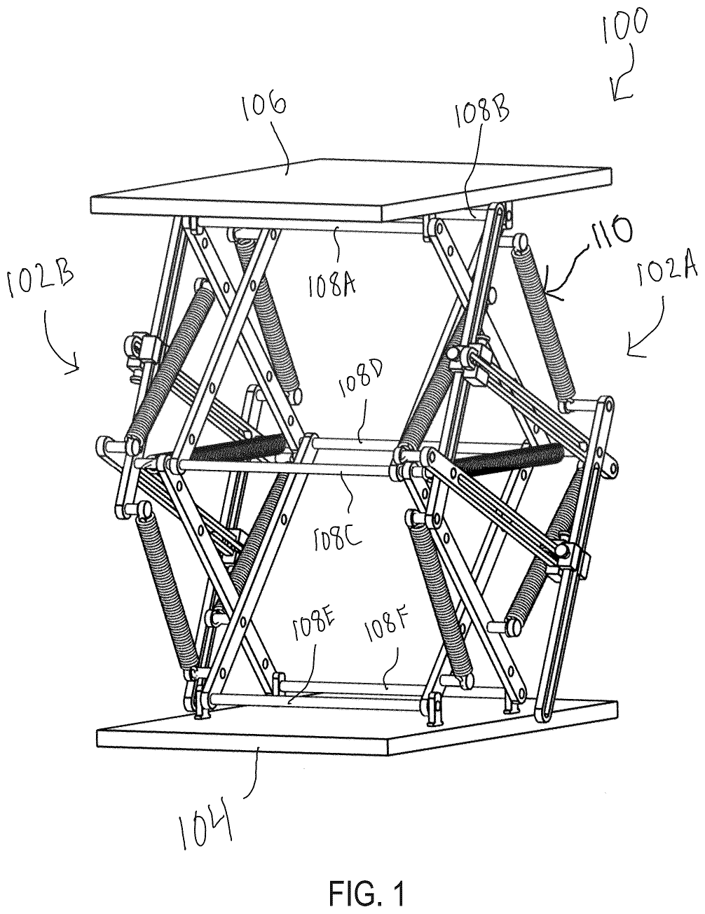

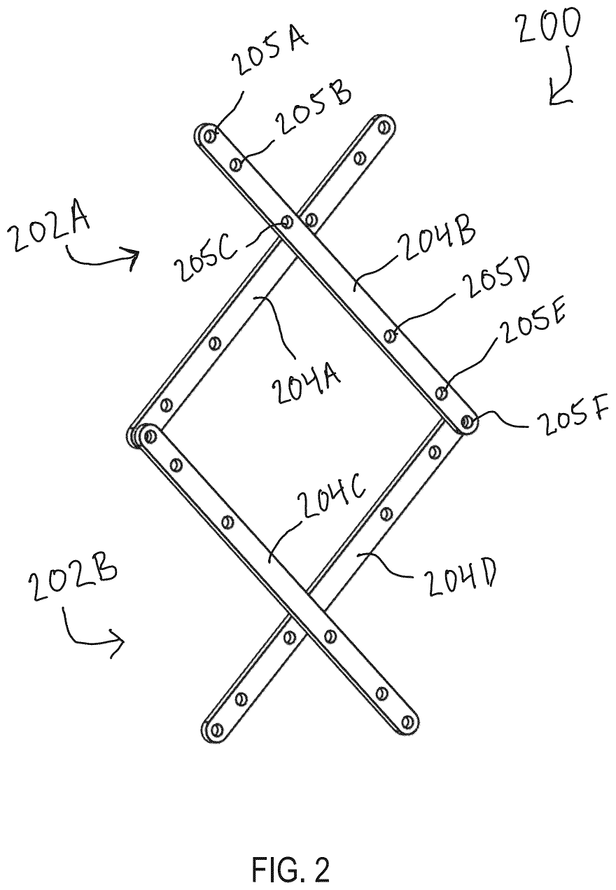

FIG. 1 shows a perspective view of an example vibration suppression system 100. In this example, vibration suppression system 100 includes a first side 102A of support members and a second side 102B of support members that opposes the first side 102A. While only the first side 102A of the vibration suppression system 100 will be described in detail in connection with the following FIGS. 2 to 7, it will be appreciated that the second side 102B of the vibration suppression system 100 may be a mirror image of the first side 102A. A plurality of support bars 108A-108F may extend between the first side 102A and the second side 102B that provide stability or support to the vibration suppression system 100. Each of the plurality of support bars 108A-108F may form a portion of a rotation joint.

The vibration suppression system 100 can also include a plurality of resilient members 110. The plurality of resilient members 110 provide a damping effect to vibration suppression system 100. In an example, each of the plurality of resilient members 110 may be a spring.

Each of the first side 102A and the second side 102B may be coupled to a first base portion 104 and a second base portion 106. In some aspects, the first base portion 104 or the second base portion 106 may be coupled to another structure. For example, in a vehicular application, the first base portion 104 may be coupled to a vehicle frame while the second base portion 106 may be coupled to a vehicle seat. In other aspects, the first base portion 104 or the second base portion 106 may integrated with a structure. For example, in the same vehicular application, the first base portion 104 may be a portion of the vehicular frame while the second base portion 106 may be a portion of the vehicle seat.

Referring to FIG. 2, a first support structure 200 of the first side 102A of the vibration suppression system 100 is shown. The first support structure 200 includes a first X-shaped support structure 202A that is formed by a support member 204A and a support member 204B. The first X-shaped support structure 202A is X-shaped in that the support member 204A and the support member 204B cross over one another to form an “X”. In at least some aspects, the support member 204A the support member 204B do not contact one another at the crossover point. The first support structure 200 further includes a second X-shaped support structure 202B that is formed by a support member 204C and a support member 204D, which are arranged similar to the support member 204A and the support member 204B. Each of the support members 204A, 204B, 204C, and 204D may be a bar (e.g., rod) of suitable stiffness. Each of the support members 204A, 204B, 204C, and 204D may have an equal length.

A plurality of openings 205A-205F are included on each of the support members 204A-204D. The plurality of openings 205A-205F are configured for forming rotation joints with other components of the vibration suppression system 100, as will be described below. In various aspects, each of the support members 204A-204D may include more or less openings 205A-205F, or a different arrangement of openings 205A-205F, than illustrated. An arrangement of the first support structure 200 can be varied depending on which of the plurality of openings 205A-205F are selected for the rotation joints.

For example, the opening 205F of the support member 204B is shown to be aligned with the opening 205A of the support member 204D in FIG. 2 for the formation of a rotation joint. In another example, the opening 205E of the support member 204B could be selected to be aligned with the opening 204A of the support member 204D for the formation of the rotation joint. In another example, certain openings 205A-205F may be selected for the rotation joints of the plurality of springs 110. In this way, various arrangements of the first support structure 200 can be selected according to intended engineering requirements for a particular use case. Once selected, however, the arrangement of the first support structure 200 cannot be adjusted without disassembling vibration suppression system 100. In this way, the first support structure 200 is non-adjustable.

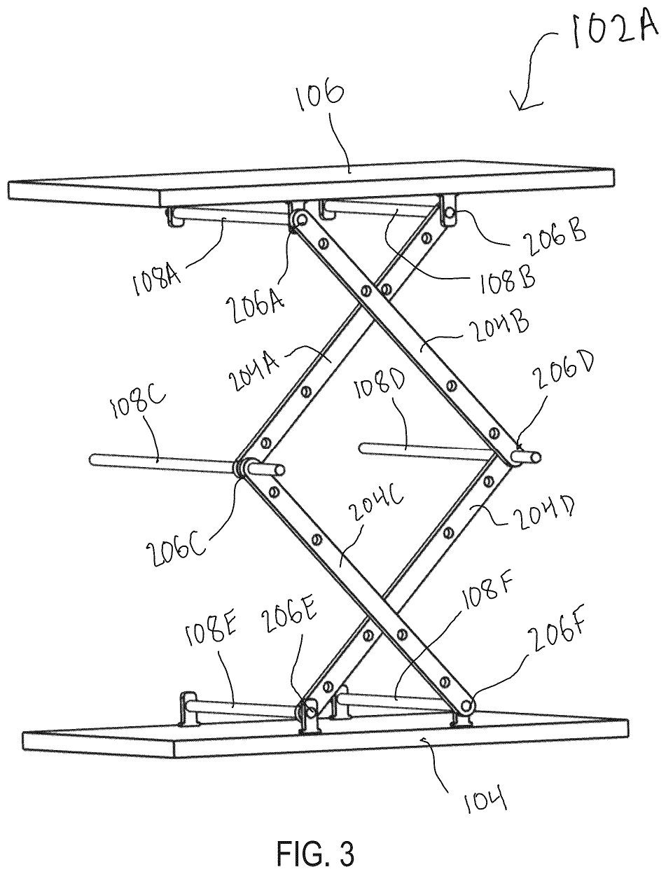

FIG. 3 shows the non-adjustable support structure 200 of the first side 102A coupled to the first base portion 104 and the second base portion 106. For instance, the support member 204A is coupled to the second base portion 106 at a rotation joint 206B by the support bar 108B. The support member 204B is coupled to the second base portion 106 at a rotation joint 206A by the support bar 108A. The support member 204C is coupled to the first base portion 104 at a rotation joint 206F by the support bar 108F. The support member 204 is coupled to the first base portion 104 at a rotation joint 206E by the support bar 108E. The support member 204A is further coupled to the support member 204C at a rotation joint 206C by the support bar 108C. The support member 204B is further coupled to the support member 204D at a rotation joint 206D by the support bar 108D.

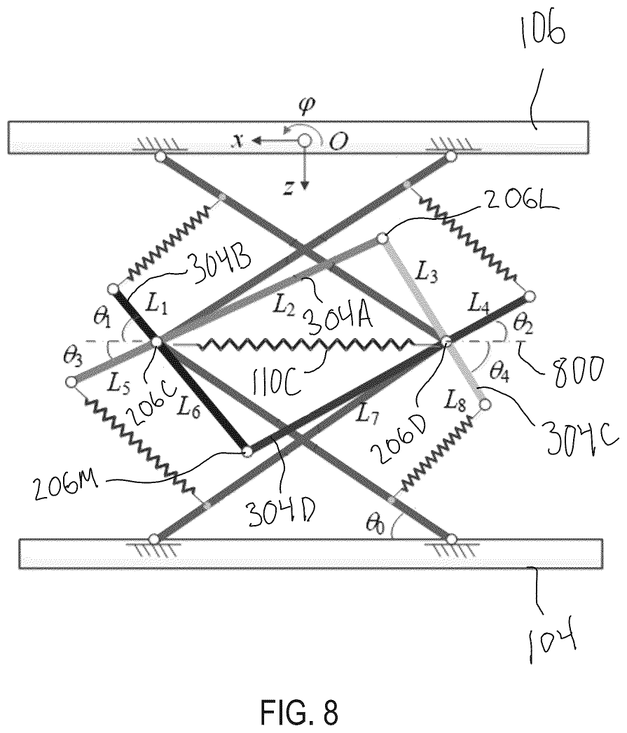

In at least some aspects, a straight line extends through the rotation joints 206A, 206C, and 206E when the vibration suppression system 100 is at rest. Similarly, a straight line may extend through the rotation joints 206B, 206D, and 206F when the vibration suppression system 100 is at rest. Either of the straight lines may be perpendicular to a plane extending through the rotation joints 206C and 206D (e.g., see plane 800 of FIG. 8).

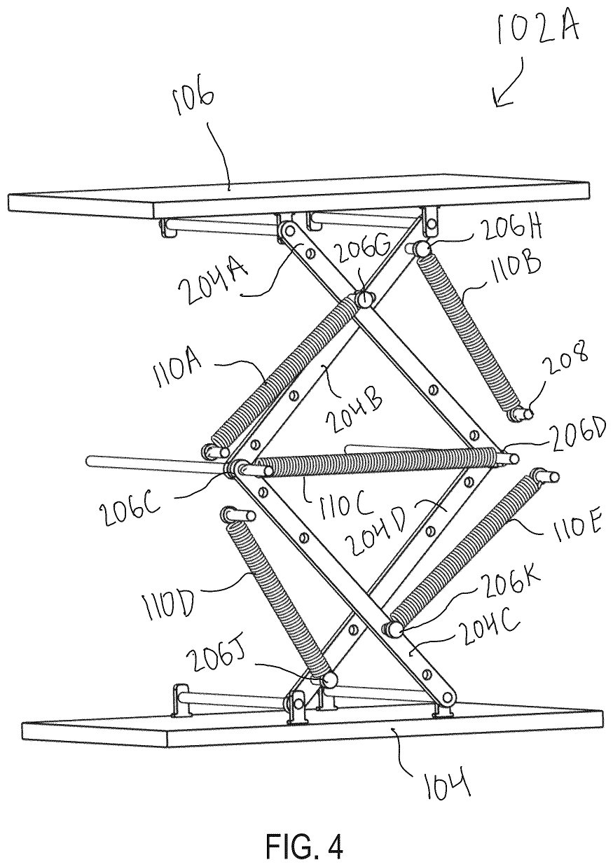

FIG. 4 shows the plurality of springs 110 coupled to the non-adjustable support structure 200. For instance, an end of a spring 110A is coupled to the support member 204A at a rotation joint 206G. An end of a spring 110B is coupled to the support member 204B at a rotation joint 206H. An end of a spring 110C is coupled to the support member 204B and the support member 204C at a rotation joint 206C. The other end of the spring 110C is coupled to the support member 204A and the support member 204D at a rotation joint 206D. An end of a spring 110D is coupled to the support member 204D at a rotation joint 206J. An end of a spring 110E is coupled to the support member 204C at a rotation joint 206K. Each of the ends of the springs 110A, 110B, 110D, and 110E are coupled to the respective support members 204A-204D by a bar 208. The ends of the spring 110C are coupled to the respective support members 204A-204D by the support bars 108C and 108D, respectively.

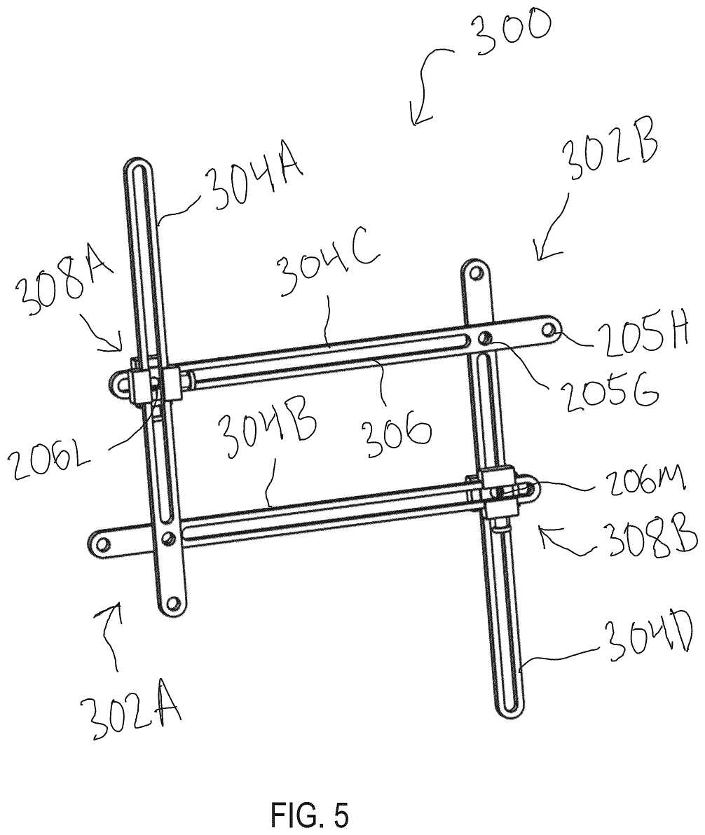

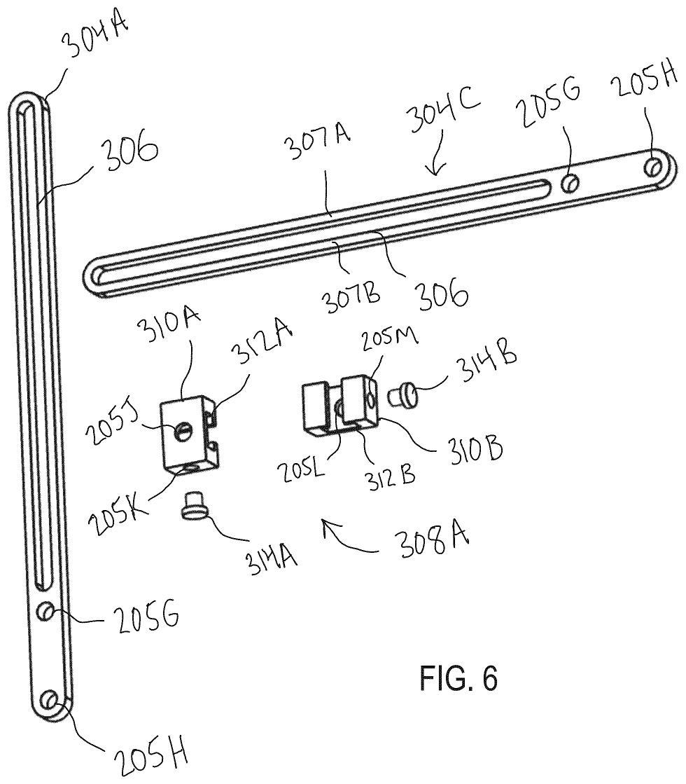

Referring now to FIGS. 5 and 6, a second support structure 300 of the first side 102A of the vibration suppression system 100 is shown. The second support structure 300 includes a first X-shaped support structure 302A that is formed by a support member 304A and a support member 304B. The first X-shaped support structure 302A is X-shaped in that the support member 304A and the support member 304B cross over one another to form an “X”. The second support structure 200 further includes a second X-shaped support structure 302B that is formed by a support member 304C and a support member 304D, which are arranged similar to the support member 304A and the support member 304B.

Each of the support members 304A, 304B, 304C, and 304D may be a bar (e.g., rod) of suitable stiffness. Openings 205G, 205H are included on each of the support members 304A-304D. The openings 205G, 205H are configured for forming rotation joints with other components of the vibration suppression system 100, as will be described below. In various aspects, each of the support members 304A-304D may include additional openings 205G, 205H, or a different arrangement of openings 205G, 205H, than illustrated. Each of the support members 304A-304D also includes arms 307A, 307B defining an elongated opening 306. It will be appreciated that the support members 304A-304D may have other suitable shapes that can achieve the same or similar adjustability property.

The second support structure 300 additionally includes a bracket assembly 308A that couples the support member 304A and the support member 304C at a rotation joint 206L. The bracket assembly 308A includes a bracket 310A and a bracket 310B. The bracket 310A includes a track 312A and the bracket 310B includes a track 312B. The support member 304C may be disposed through the track 312A, which couples the support member 304C to the bracket 310A. The support member 304A may be disposed through the track 312B, which couples the support member 304A to the bracket 310B.

The brackets 310A and 310B respectively include openings 205J and 205L that are configured for forming a rotation joint 206L. For instance a rod 208 may be positioned through the openings 205J and 205L such that the bracket 310A and the bracket 310B can rotate relative to one another about an axis extending through the rod 208. The rod 208 may extend through at least one of the elongated openings 306 of the support members 304A and 304C. The rotation joint 206L includes the bracket assembly 308A and the rod 208.

The brackets 310A and 310B may also respectively include openings 205K and 205M. An adjustment member 314A may be positioned within the opening 205K. For example, the adjustment member 314A (e.g., a screw) may include at least one exterior thread, and the opening 205K may include at least one interior thread, such that the adjustment member 314A may be threaded into the opening 205K. In this example, with the support member 304C disposed through the track 312A, sufficiently tightening the adjustment member 314A against the support member 304A (e.g., against the arm 307 A or the arm 307 B) restricts translation of the support member 304C and the bracket 310A relative to one another. Stated differently, the bracket 310A is fixed relative to the support member 304C when the adjustment member 314A is in a first state in which the adjustment member 314A is sufficiently tightened.

When the adjustment member 314A is insufficiently tightened against (e.g., loosened from) the support member 304A, the support member 304C and the bracket 310A are allowed to translate relative to one another. Stated differently, the bracket 310A is translatable relative to the support member 304C when the adjustment member 314A is in a second state in which the adjustment member 314A is insufficiently tightened to fix the bracket 310A. When the bracket 310A is in a desired position along the support member 304C, the adjustment member 314A can be transitioned to the first state to again fix the bracket 310 relative to the support member 304A.

An adjustment member 314B may be positioned within the opening 205M of the bracket 310B similar to the adjustment member 314A. With the support member 304A disposed through the track 312B, the adjustment member 314B may similarly be transitioned between the first and second state to restrict or allow translation of the support member 304A relative to the bracket 310B. In this way, the bracket assembly 308A is configured to selectively allow or restrict translation of the support member 304A or the support member 304C relative to the bracket assembly 308A. For instance, the bracket 310A is configured to selectively allow or restrict translation of the support member 304C relative to the bracket 310A, and the bracket 310B is configured to selectively allow or restrict translation of the support member 304A relative to the bracket 310B.

The bracket assembly 308B is configured similarly to the bracket assembly 308A such that the bracket assembly 308B is configured to selectively allow or restrict translation of the support member 304B or the support member 304D relative to the bracket assembly 308B. For instance, the bracket 310A of the bracket assembly 308B is configured to selectively allow or restrict translation of the support member 304D relative to the bracket 310A of the bracket assembly 308B, and the bracket 310B of the bracket assembly 308B is configured to selectively allow or restrict translation of the support member 304B relative to the bracket 310B of the bracket assembly 308B. In this way, the second support structure 300 is adjustable by way of the bracket assemblies 308A, 308B. It should be appreciated that the bracket assemblies 308A, 308B are only one example of a structure suitable to selectively allow or restrict translation of support members relative to one another and other suitable structures may be used instead of the bracket assemblies 308A, 308B.

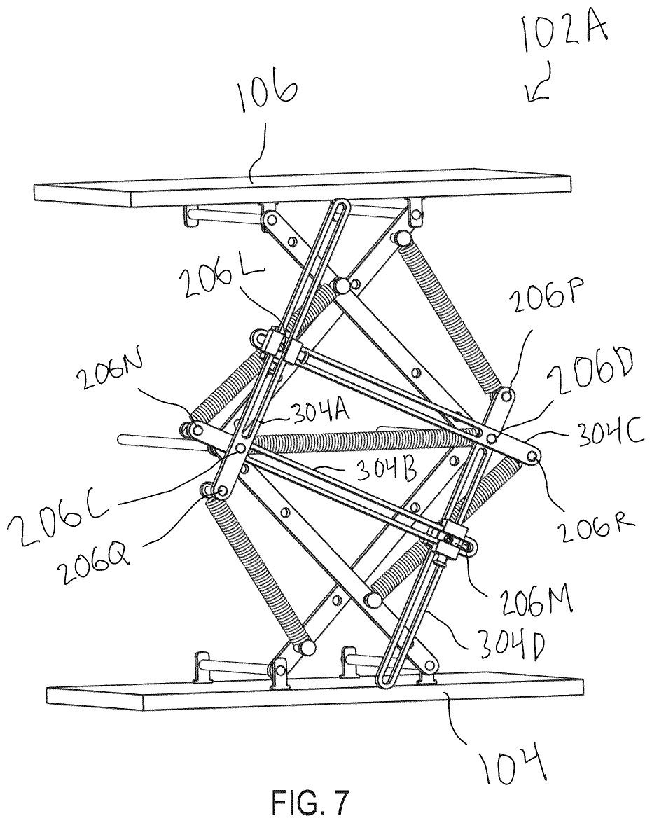

Referring now to FIG. 7, the adjustable support structure 300 of the first side 102A is shown coupled to the non-adjustable support structure 200 and to the plurality of springs 110. For instance, the support member 304A is coupled to the spring 110D at a rotation joint 206 Q. The support member 304B is coupled to the spring 110A at a rotation joint 206 N. The support members 304A and 304B are further coupled to the non-adjustable support structure 200 and the spring 110C at the rotation joint 206C. The support member 304C is coupled to the spring 110E at a rotation joint 206 R. The support member 304D is coupled to the spring 110B at a rotation joint 206 P. The support members 304C and 304D are further coupled to the non-adjustable support structure 200 and the spring 110C at the rotation joint 206C.

Based on the adjustability of the adjustable support structure 300 afforded by the bracket assemblies 308A and 308B, distances between various rotation joints may be adjusted. For example, a distance (e.g., straight-line distance) between the rotation joint 206C and the rotation joint 206L may be adjusted. In another example, a distance between the rotation joint 206C and the rotation joint 206M may be adjusted. In another example, a distance between the rotation joint 206D and the rotation joint 206L may be adjusted. In another example, a distance between the rotation joint 206D and the rotation joint 206M may be adjusted.

Stated in another way, a length of a respective support member 304A-304D between two respective rotation joints 206C, 206D, 206L, 206M is adjustable based on the adjustability of the bracket assemblies 308A and 308B at the rotation joints 206L and 206M. For example, with reference to the schematic of FIG. 8, a length L₂ of the support member 304A between the rotation joints 206C and 206L, a length L₆ of the support member 304B between the rotation joints 206C and 206M, a length L₃ of the support member 304C between the rotation joints 206L and 206D, and a length L₇ of the support member 304D between the rotation joints 206D and 206M are each adjustable.

Further shown in FIG. 8 are length L₅ of the support member 304A, length L₁ of the support member 304B, length La of the support member 304C, and length L₄ of the support member 304D, which are separated from the above-described lengths L₂, L₆, L₃, L₇ by rotation joint 206C or 206B. The inventors have found that adjusting the ratios between lengths L₁-L₈ can alter the vibration suppression characteristics of the vibration suppression system 100. For example, adjusting the ratio between L₂ and L₃ by translating the bracket assembly 308A of the rotation joint 206L along the support member 304A or 304C, or both.

Adjusting the lengths L₁-L₈ can also adjust the angles at which the support members 304A-304D are disposed relative to a plane 800 that extends perpendicular to the support member 304A-304D and lengthwise through the spring 110C. For example, the support member 304A forms an angle θ₃ with the plane 800, the support member 304B forms an angle θ₁ with the plane 800, the support member 304C forms an angle θ₄ with the plane 800, and the support member 304D forms an angle θ₂ with the plane 800. One or more of the angles θ₁, θ₂, θ₃, and θ₄ may be altered by adjusting a position of one or both of the bracket assemblies 308A, 308B.

It should be appreciated that adjusting the distances between the rotation joints 206C, 206D, 206L, 206M (or adjusting the first and second lengths of the support members 304A-304D) may result in the support member 304A and the support member 304C forming a third X-shaped structure and/or the support member 304B and the support member 304D forming a fourth X-shaped structure. The ability to adjust the distances between the rotation joints 206C, 206D, 206L, 206M provides an easy and flexible way to adjust the static and dynamic performance of the vibration suppression system 100 without replacing any of the plurality of springs 110.

In use, portions of first base portion 104 move towards and away from second base portion 106 in response to force(s) applied to vibration suppression system 100 and a relaxation of such force(s). For example, a mass (e.g. cargo, an individual, etc.) may rest on base portion 104, which compresses base portion 104 towards base portion 106, and as the mass moves within space (e.g. a bump on a road causes cargo in a truck to move), base portion 104 moves away from and towards base portion 106. In some aspects, portions of base portion 106 may similarly move towards and away from base portion 104. Support members 204A-204D and 304A-304D rotate about rotation joints 206A-206R to enable the change in distance between portions of first base portion 104 and second base portion 106.

The inventors have found that the loading capacity, the effective working zone and the nonlinear stiffness of the vibration suppression system 100 in the three moving directions can be affected by a stiffness of the plurality of springs 110, the connection parameters of the plurality of springs 110, and the ratios between the lengths L₁-L₈. The inventors have also found that, for a set stiffness and set connection parameters of the plurality of springs 110, the loading capacity, the effective working zone and the QZS performance in the three working directions can be easily improved by tuning the ratios between the lengths L₁-L₈ using the bracket assemblies 308A, 308B, which demonstrates that the adjustable support structure 300 can provide easy and flexible tuning of the static and dynamic performance of the vibration suppression system 100.

The inventors have also found that an increase of base excitation amplitude does not result in frequency jumping phenomenon and softening and hardening effects of the vibration suppression system 100. Instead, the vibration suppression system 100 exhibits stable and excellent vibration isolation performance even if the vibration suppression system 100 is affected by external excitations with large amplitudes, which is a beneficial property that is superior to conventional vibration isolators and enables the vibration suppression system 100 to be applied to engineering structures under excitations with large amplitudes.

In one or more aspects, the present vibration suppression system may include additional aspects, such as any single aspect or any combination of aspects described below or in connection with one or more other processes or devices described elsewhere herein. The numbers in parentheses throughout the following description of these aspects denote the reference numerals used in the above description with reference to the figures. The reference numerals are included as example implementations of each of the elements recited in the below aspects.

In a first aspect, a vibration suppression system (100) includes a first support structure (200), a second support structure (300), and a plurality of resilient members (110). The first support structure includes: a first support member (204A), a second support member (204B), a third support member (204C) coupled to the second support member (204B) at a first rotation joint (206C), and a fourth support member (204D) coupled to the first support member (204A) at a second rotation joint (206D). The second support structure (300) is coupled to the first support structure (200) and includes: a fifth support member (304A), a sixth support member (304B) coupled to the fifth support member (304A) at the first rotation joint (206C), and a seventh support member (304C) coupled to the fifth support member (304A) at a third rotation joint (206L). A distance between the first rotation joint (206C) and the third rotation joint (206L) is adjustable. The plurality of resilient members (110) are coupled to at least one of the first support structure (200) or the second support structure (300).

In a second aspect, in combination with the first aspect, the first support structure (200) is arranged such that the first support member (204A) crosses over the second support member (204B) and the third support member (204C) crosses over the fourth support member (204D).

In a third aspect, in combination with one or more of the first aspect or the second aspect, the second support structure (300) further includes an eighth support member (304D) coupled to the seventh support member (304C) at the second rotation joint (206D) and to the sixth support member (304B) at a fourth rotation joint (206M).

In a fourth aspect, in combination with the third aspect, a distance between the second rotation joint (206D) and the fourth rotation joint (206M) is adjustable.

In a fifth aspect, in combination with one or more of the third aspect through the fourth aspect, a distance between the first rotation joint (206C) and the fourth rotation joint (206M) is adjustable.

In a sixth aspect, in combination with one or more of the third aspect through the fifth aspect, a distance between the second rotation joint (206D) and the third rotation joint (206L) is adjustable.

In a seventh aspect, in combination with one or more of the first aspect through the sixth aspect, the plurality of resilient members include a first resilient member (110A) coupled to the first support structure (200) at a fifth rotation joint (206G) and to the second support structure (300) at a sixth rotation joint (206N).

In an eighth aspect, in combination the seventh aspect, the plurality of resilient members further include: a second resilient member (110B) coupled to the first support structure (200) at a seventh rotation joint (206H) and to the second support structure (300) at a eighth rotation joint (206P); and a third resilient member (110C) coupled to the first support structure (200) and to the second support structure (300) at the first and second rotation joints.

In a ninth aspect, a vibration suppression system (100) includes a first support structure (200) and a second support structure (300). The first support structure (200) includes a first X-shaped structure (202A) and a second X-shaped structure (202B) coupled to the first X-shaped structure (202A) at a first rotation joint (206C) and at a second rotation joint (206D). The second support structure (300) includes a third X-shaped support structure (302A) coupled to the first support structure (200) at the first rotation joint (206C), and a fourth X-shaped support structure (302B) coupled to the first support structure (200) at the second rotation joint (206D). The third X-shaped support structure (302A) is coupled to the fourth X-shaped support structure (302B) at a third rotation joint (206L) and at a fourth rotation joint (206M). A distance between the first rotation joint (206C) and the third rotation joint (206L), and a distance between the first rotation joint (206C) and the fourth rotation joint (206M), is adjustable.

In a tenth aspect, in combination with the ninth aspect, a distance between the second rotation joint (206D) and the third rotation joint (206L), and a distance between the second rotation joint (206D) and the fourth rotation joint (206M), is adjustable.

In an eleventh aspect, in combination with one or more of the ninth aspect through the tenth aspect, the third rotation joint (206L) includes a first bracket (310A) and a second bracket (310B). A portion of the fourth X-shaped support structure (302B) is disposed within the first bracket (310A) and a portion of the third X-shaped support structure (302A) is disposed within the second bracket (310B).

In a twelfth aspect, in combination with the eleventh aspect, the first bracket (310A) is rotatable relative to the second bracket (310B) about an axis of the third rotation joint (206L).

In a thirteenth aspect, in combination with one or more of the ninth aspect through the twelfth aspect, the vibration suppression system further includes a resilient member (110C) coupled to the first and second support structures at the first rotation joint (206C) and at the second rotation joint (206D).

In a fourteenth aspect, a vibration suppression system (100) includes a first support structure (200) and a second support structure (300). The second support structure (300) includes a first support member (304A), a second support member (304B) coupled to the first support member (304A) and the first support structure (200) at a first rotation joint (206C), a third support member (304C) coupled to the first support member (304A) at a second rotation joint (206L), and a fourth support member (304D) coupled to the third support member (304C) and the first support structure (200) at a third rotation joint (206D). The fourth support member (304D) is further coupled to the second support member (304B) at a fourth rotation joint (206M). The second rotation joint (206L) includes a bracket (310B) through which the first support member (304A) is disposed. The bracket (310B) is configured to selectively allow or restrict translation of the first support member (304A) relative to the bracket (310B).

In a fifteenth aspect, in combination with the fourteenth aspect, the second rotation joint (206L) further includes a second bracket (310A) through which the third support member (304C) is disposed, wherein the second bracket (310A) is configured to selectively allow or restrict translation of the third support member (304C) relative to the second bracket (310A).

In a sixteenth aspect, in combination with one or more of the fourteenth aspect through the fifteenth aspect, the fourth rotation joint (206M) includes a second bracket (310B of 206M) through which the second support member (304B) is disposed. The second bracket (310B of 206M) is configured to selectively allow or restrict translation of the second support member (304B) relative to the second bracket (310B of 206M).

In a seventeenth aspect, in combination with one or more of the fourteenth aspect through the sixteenth aspect, the first support member (304A) crosses over the second support member (304B) at the first rotation joint (206C) to thereby form an X-shaped structure.

In an eighteenth aspect, in combination with the seventeenth aspect, the third support member (304C) crosses over the fourth support member (304D) at the second rotation joint (206D) to thereby form an X-shaped structure.

In a nineteenth aspect, in combination with one or more of the fourteenth aspect through the eighteenth aspect, the vibration suppression system further includes a plurality of resilient members (110) coupled to the first and second support structures (200, 300).

In a twentieth aspect, in combination with one or more of the first aspect through the nineteenth aspect, each of the plurality of resilient members (110A-110E) is a spring.

In a twenty-first aspect, a vibration suppression system (100) includes a first support structure (200) and a second support structure (300) coupled to the first support structure (200). The first support structure (200) includes a first plurality of support members (204A-204D) and a first plurality of rotation joints (206A-206K). The second support structure (300) includes a second plurality of support members (304A-304D) and a second plurality of rotation joints (206C, 206D, 206L-206R). The second plurality of rotation joints includes a portion (206C, 206D) of the first plurality of rotation joints, and a distance between a first rotation joint (206C) of the second plurality of rotation joints and a second rotation joint (206L) of the second plurality of rotation joints is adjustable.

In a twenty-second aspect, in combination with the twenty-first aspect, the second support structure (300) is coupled to the first support structure (200) at the first rotation joint (206C).

In a twenty-third aspect, in combination with one or more of the twenty-first aspect through the twenty-second aspect, the second rotation joint (206L) includes a bracket (310A) through which a first support member (304C) of the second plurality of support members is disposed, and the bracket (310A) is configured to selectively allow or restrict translation of the first support member (304C) relative to the bracket (310A).

In a twenty-fourth aspect, in combination with the twenty-third aspect, the second rotation joint (206L) further includes a second bracket (310B) through which a second support member (304A) of the second plurality of support members is disposed, and the second bracket (310B) is configured to selectively allow or restrict translation of the second support member (304A) relative to the second bracket (310B).

In a twenty-fifth aspect, in combination with one or more of the twenty-first aspect through the twenty-fourth aspect, a distance between the first rotation joint (206C) and a third rotation joint (206M) of the second plurality of rotation joints is adjustable.

The above specification and examples provide a complete description of the structure and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the products, systems, and methods are not intended to be limited to the particular forms disclosed. Rather, they include all modifications and alternatives falling within the scope of the claims, and embodiments other than the one shown may include some or all of the features of the depicted embodiment. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

What is claimed is:

1. A vibration suppression system comprising:
a first support structure including:
a first support member,
a second support member,
a third support member coupled to the second support member at a first rotation joint, and
a fourth support member coupled to the first support member at a second rotation joint;
a second support structure coupled to the first support structure and including:
a fifth support member coupled to the first support structure at the first rotation joint,
a sixth support member coupled to the first support structure at the second rotation joint and to the fifth support member at a third rotation joint,
wherein a distance between the first rotation joint and the third rotation joint is adjustable; and
a plurality of resilient members coupled to at least one of the first support structure or the second support structure.

2. The vibration suppression system of claim 1, wherein the first support structure is arranged such that the first support member crosses over the second support member and the third support member crosses over the fourth support member.

3. The vibration suppression system of claim 1, wherein the second support structure further includes an eighth support member coupled to the seventh support member at the second rotation joint and to the sixth support member at a fourth rotation joint.

4. The vibration suppression system of claim 3, wherein a distance between the second rotation joint and the fourth rotation joint is adjustable.

5. The vibration suppression system of claim 3, wherein a distance between the first rotation joint and the fourth rotation joint is adjustable.

6. The vibration suppression system of claim 3, wherein a distance between the second rotation joint and the third rotation joint is adjustable.

7. The vibration suppression system of claim 1, wherein the plurality of resilient members include a first resilient member coupled to the first support structure at a fifth rotation joint and to the second support structure at a sixth rotation joint.

8. The vibration suppression system of claim 7, wherein the plurality of resilient members further include:
a second resilient member coupled to the first support structure at a seventh rotation joint and to the second support structure at a eighth rotation joint; and
a third resilient member coupled to the first support structure and to the second support structure at the first and second rotation joints.

9. The vibration suppression system of claim 1, wherein each of the plurality of resilient members is a spring.

10. A vibration suppression system comprising:
a first support structure including:
a first X-shaped structure, and
a second X-shaped structure coupled to the first X-shaped structure at a first rotation joint and at a second rotation joint; and
a second support structure including:
a third X-shaped support structure coupled to the first support structure at the first rotation joint, and
a fourth X-shaped support structure coupled to the first support structure at the second rotation joint,
wherein the third X-shaped support structure is coupled to the fourth X-shaped support structure at a third rotation joint and at a fourth rotation joint, and
wherein a distance between the first rotation joint and the third rotation joint, and a distance between the first rotation joint and the fourth rotation joint, is adjustable.

11. The vibration suppression system of claim 10, wherein a distance between the second rotation joint and the third rotation joint, and a distance between the second rotation joint and the fourth rotation joint, is adjustable.

12. The vibration suppression system of claim 10, wherein:
the third rotation joint includes a first bracket and a second bracket, and
a portion of the fourth X-shaped support structure is disposed within the first bracket and a portion of the third X-shaped support structure is disposed within the second bracket.

13. The vibration suppression system of claim 12, wherein the first bracket is rotatable relative to the second bracket about an axis of the third rotation joint.

14. The vibration suppression system of claim 10, further comprising a resilient member coupled to the first and second support structures at the first rotation joint and at the second rotation joint.

15. A vibration suppression system comprising:
a first support structure including a first plurality of support members and a first plurality of rotation joints; and
a second support structure coupled to the first support structure, the second support structure including a second plurality of support members and a second plurality of rotation joints, wherein the second plurality of rotation joints includes a portion of the first plurality of rotation joints,
wherein a distance between a first rotation joint of the second plurality of rotation joints and a second rotation joint of the second plurality of rotation joints is adjustable.

16. The vibration suppression system of claim 15, wherein the second support structure is coupled to the first support structure at the first rotation joint.

17. The vibration suppression system of claim 15, wherein:
the second rotation joint includes a bracket through which a first support member of the second plurality of support members is disposed, and
the bracket is configured to selectively allow or restrict translation of the first support member relative to the bracket.

18. The vibration suppression system of claim 17, wherein:
the second rotation joint further includes a second bracket through which a second support member of the second plurality of support members is disposed, and
the second bracket is configured to selectively allow or restrict translation of the second support member relative to the second bracket.

19. The vibration suppression system of claim 15, wherein a distance between the first rotation joint and a third rotation joint of the second plurality of rotation joints is adjustable.

20. The vibration suppression system of claim 15, further comprising a plurality of resilient members coupled to the first and second support structures.
